(19) United States
(12) Patent Application Publication
(10) Pub. No.: US 2005/0171806 A1
(43) Pub. Date: Aug. 4, 2005

(54) Method and apparatus for presentation of product notices using transitory perception of a candidate product

(76) Inventor: Jack Ivan J'maev, Chino, CA (US)

Correspondence Address: Jack I. J'maev, 187 W. Orangethorpe Ave., Placentia, CA, 92870, US

(21) Appl. No.: 11/025,362

(22) Filed: Dec. 28, 2004

Related U.S. Application Data
(63) Continuation-in-part of application No. 10/615,345, filed on Jul. 7, 2003.
(63) Continuation-in-part of application No. 10/850,476, filed on May 19, 2004.
(63) Continuation-in-part of application No. 10/848,996, filed on May 18, 2004.
(60) Provisional application No. 60/533,082, filed on Dec. 29, 2003.
(60) Provisional application No. 60/394,980, filed on Jul. 9, 2002.
(60) Provisional application No. 60/471,976, filed on May 19, 2003.

(51) Int. Cl. G06F 17/60

(52) U.S. Cl. 705/1

(57) ABSTRACT

Disclosed are a method and apparatus for presenting a product notice to a user by receiving a product notice, perceiving a candidate product, determining a product identifier for the perceived candidate product and presenting the received product notice to a user when a product identifier included in the received message is substantially equivalent to a determined product identifier for a perceived candidate product.

### RELATED APPLICATIONS

The present application claims priority to Provisional Application No. 60/533,082 filed on Dec. 29, 2003, entitled “Method and Apparatus for Presentation of Product Notices Using Transitory Perception of a Candidate Product” by J'maev; the present application is also a continuation-in-part of and claims priority to U.S. patent application entitled “Method and Apparatus for Issuing Product Notices” by J'maev (application Ser. No. 10/615,345) filed as a non-provisional application on Jul. 7, 2003 which itself claims priority to a provisional application 60/394,980) filed on Jul. 9, 2002; the present application is also a continuation-in-part of and claims priority to non-provisional U.S. application Ser. No. 10/850,476 entitled “Method and Apparatus for Product-Centric Delivery of Product User Notices” by J'maev filed on May 19, 2003 which itself claims priority to a provisional application (Application No. 60/471,976) filed on May 19, 2003; the present application is also a continuation-in-part of and claims priority to “Method and Apparatus for Recall of Products Having Subordinate Components Subject to Recall” by J'maev filed on May 18, 2004 and claiming priority to a provisional filed on May 19, 2003 (U.S. patent application Ser. Nos. 10/848,996 and 60/471,927); all of the foregoing related applications are incorporated herein by reference in their entirety.

### BACKGROUND

Traditionally, many types of products have been subject to cursory inspection as they entered and flowed through the stream of commerce. Such cursory inspection was an adequate means of identifying when a product was not fit for use. For example, common food products have always been subject to such cursory inspection whenever the product was conveyed either from a manufacturer to a distributor, from a distributor to a retailer and ultimately when it was delivered to a consumer. Such cursory inspections were adequate because there was a higher level of care attendant at each stage of the delivery process. Manufacturers were usually small enterprises that could more easily cope with their production rates so that the term cursory inspection was in fact, according to today's standards, rather rigorous and thorough. Consider a small local dairy that a couple of decades ago produced a few hundred gallons of milk or a small chicken farm that produced a few hundred dozen eggs each day. In these small quantities, quality inspections could easily identify sour milk or putrid eggs. Such inspections could easily be carried out by a small distributor that serviced perhaps as few as ten grocery stores. At each grocery store, a shop keeper could provide additional inspection in order to prevent delivery of unfit products either as they arrived “on dock” or as they moved through the check stand.

Today, our society needs a recall management system that can deal effectively with large production quantities and complex distribution systems. This is because manufacturers, distributors and retailers are now big businesses that deliver thousands of dozens of eggs and thousands of gallons of milk every day. Given such huge quantities, there simply has been no way to keep up with the standard of care that requires cursory inspection of products at most levels in the distribution chain; let alone the greater standard of care imposed on manufactures and producers to ensure the delivery of non-defective products into the stream of commerce.

Milk and eggs are merely two examples of products that can be delivered to a consumer in an unfit state. All sorts of products can be delivered into the stream of commerce that are either unfit (e.g. defective) in the first place or deteriorate into an unfit state over time (e.g. milk that goes sour after a week or so). The types of products that are included in this category are simply too numerous to mention and are not even limited to food products. For example, medicines, vitamins, electric blankets, pocket knives, furniture, television sets, computers and more all can either be either defective when they enter the stream of commerce or become unfit for use with the passage of time.

### SUMMARY

Disclosed are a method and apparatus for presenting a product notice to a user by receiving a product notice, perceiving a candidate product, determining a product identifier for the perceived candidate product and presenting the received product notice to a user when a product identifier included in the received message is substantially equivalent to a determined product identifier for a perceived candidate product

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that depicts one illustrative method for conveying a product notice to a user;

FIG. 1A is a flow diagram that depicts alternative methods for receiving a product notice;

FIG. 1B is a flow diagram that depicts an illustrative method for accumulating product notices on a selective basis;

FIG. 2 is a flow diagram that depicts one illustrative alternative method for perceiving a candidate product using optical energy;

FIG. 3 is a flow diagram that depicts one alternative example method for perceiving a candidate product using electromagnetic (e.g. radio) energy;

FIG. 4 is a flow diagram that depicts one alternative example method for presenting a product notice;

FIG. 5 is a block diagram that depicts one example embodiment of a product notice presentation device;

FIG. 6 is a block diagram of one example embodiment of a notice data unit;

FIG. 7 is a block diagram of one illustrative embodiment of a processor-based product notice delivery apparatus;

FIG. 8 is a data flow diagram that depicts the operation of one illustrative embodiment of a processor-based product notice delivery apparatus;

FIG. 9 is a flow diagram that depicts one alternative method for presenting a product notice to a user;

FIG. 10 is a block diagram of one alternative embodiment of a product notice presentation device;

FIG. 11 is a pictorial diagram that depicts one example of a package that includes a display capability; and

FIG. 12 is a block diagram that depicts one example embodiment of a refrigerated storage unit that includes a product notice presentation device.

### DETAILED DESCRIPTION

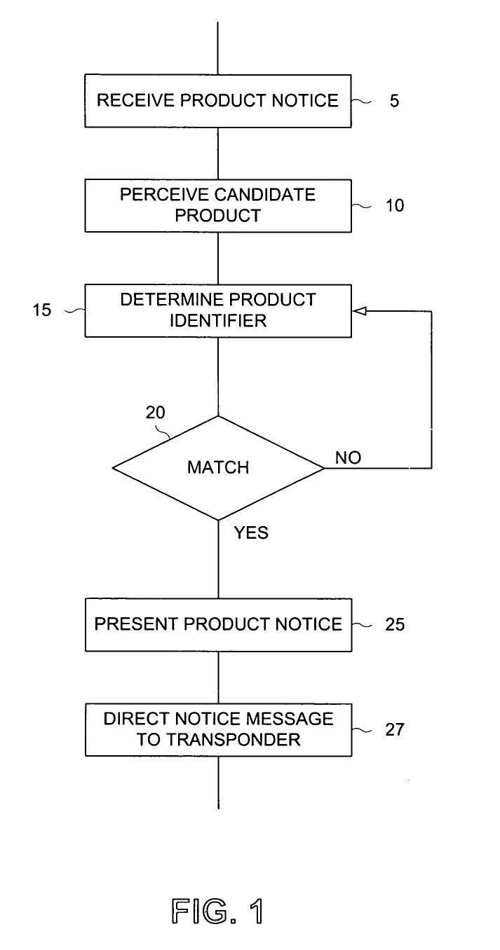

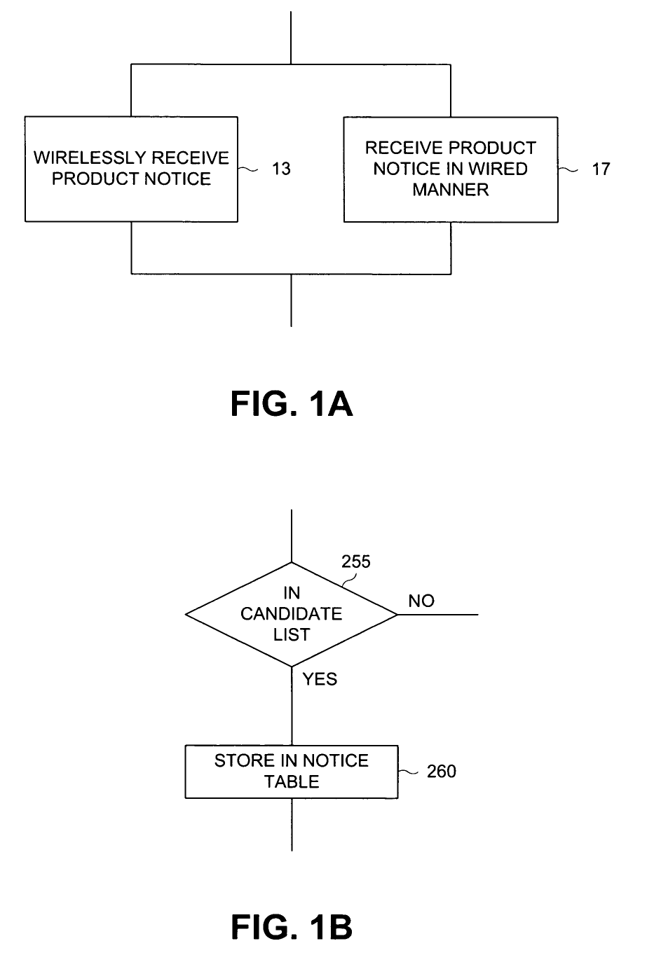

FIG. 1 is a flow diagram that depicts one illustrative method for conveying a product notice to a user. According to this illustrative method, a product notice is received (step 5). A candidate product is also perceived (step 10). A candidate product is defined as a product that can potentially be the target of a product notice, as described in the incorporated references. Once the candidate product is perceived, a product identifier is determined according to information extracted from the candidate product (step 15). In the event that the determined product identifier matches (step 20) a product identifier associated with the received product notice, the product notice is presented to a user (step 25). According to one alternative method, the product notice is presented to the user when the product identifier associated with the received product notice matches a product identifier included in a candidate product list. A candidate product list, as described infra, is created as various products are perceived over time. Accordingly, a product notice can be presented for a candidate product even after the product can no longer be perceived. It should be noted that the perception of a product, according to one example variation of the present method, is accomplished when a candidate product is either scanned by an optical bar-code reader or comes within range of a wireless identification interface device (e.g. SmartChip or RFID). It should be further appreciated that a product notice, according to yet another variation of the present method, is received at some point after a candidate product is perceived. Accordingly, the scope of the claims appended hereto is to be read in light of the fact that the order of reception of product notice and perception of candidate product can vary according to several variations of the present method.

FIG. 1A is a flow diagram that depicts alternative methods for receiving a product notice. The present method is derived from a method previously disclosed by the Applicant in a co-pending application entitled “Method and Apparatus for Recall of Products Having Subordinate Components Subject to Recall” (U.S. patent application Ser. Nos. 10/848,996 and 60/471,927), incorporated herein by reference in its entirety. In this incorporated reference, the applicant describes a method wherein a candidate product is perceived before a product notice is received. According to the previously disclosed method, a product notice is received by various alternative methods. The same is true in the present method wherein a product notice according to one alternative method is received by means of a wireless interface (step 13). Examples of a wireless interface included, but are not necessarily limited to a broadcast means, a cellular telephone interface, a satellite receiver and a wireless computer network (e.g. various embodiments of an 802.11 wireless network). The present method can be used where product notices are received using other wireless conveyance mechanisms. According to yet another alternative method, a product notice is received by means of a wired interface (step 17). Examples of wired interfaces include, but are not necessarily limited to a cable television distribution system and a computer network (e.g. the Internet). Serial data and parallel data interfaces can also be used to receive a product notice in a wired manner. These wireless and wired product notice delivery methods were first described in a co-pending patent applications entitled “Method and Apparatus for Product-Centric Delivery of Product User Notices” and “Method and Apparatus for Product Recall”, both of which have been incorporated herein by reference in their entirety.

According to one alternative method, whenever a product notice is received, it is stored in a notice table. It should be appreciated that an apparatus capable of conveying a product notice to user may only be capable of perceiving a candidate product during a brief interval of time. For example, where the present method is applied in a “point-of-sale” application, a candidate product can only be perceived when it is proximate to a point-of-sale terminal. As described infra, perception of a candidate product can be accomplished in numerous ways including, but not limited to the use of a bar-code and a wireless identification transponder included in the product or its packaging. In a situation where the present method is applied in a domestic environment (e.g. a safety notice apparatus as described infra), a candidate product can only be perceived when it is proximate to an apparatus capable of presenting product notices to a user by transiently perceiving candidate products. Accordingly, one alternative method provides for storing product notices in a notice table so that these product notices can be associated with a candidate product once such a candidate product is perceived subsequent to the receipt of the product notice.

FIG. 1B is a flow diagram that depicts an illustrative method for accumulating product notices on a selective basis. It should be appreciated that the quantity of various product notices that can be received by an apparatus capable of conveying a product notice to user may be so large that it becomes impracticable to store each product notice in anticipation of subsequently perceiving a candidate product that is a target of a particular product notice. Hence, according to this variation of the present method, a product notice that is received (step 250) is only stored in a notice table (step 260) when the product notice is targeted to a potential candidate product (step 255). For example, a potential candidate product can be included in a candidate product list maintained in an apparatus capable of conveying a product notice to a user. When a product notice is received, the candidate list is consulted in order to determine if the received product notice should be stored in the notice table. This variation of the present method can be applied in a situation where an apparatus capable of conveying a product notice to a user is situated proximate to a particular portion of shelf space. Such shelf space can include a refrigerated presentation unit typically used in a grocery store to present perishable products to a potential consumer. Such shelf space can also include normal shelf space in a retail establishment used to present other products to a potential consumer. Such shelf space can also include a shelf in a domestic or commercial refrigerator, as further described infra.

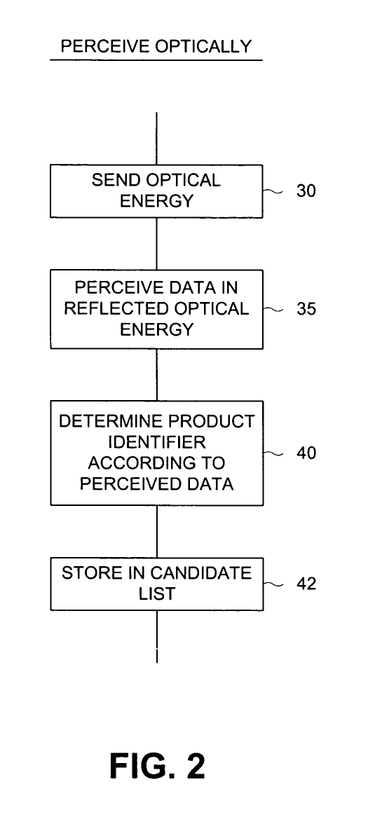

FIG. 2 is a flow diagram that depicts one illustrative alternative method for perceiving a candidate product using optical energy. According to this illustrative alternative method, a candidate product is perceived by illuminating all or a portion of a candidate product with optical energy (step 30). The optical energy, according to one alternative method, is scanned in a substantially linear manner. Typically, such substantially linear scanning of the optical energy is used to perceive digital patterns (e.g. a bar-code). Optical energy that is reflected from the digital pattern is perceived as data (step 35). The data is, according to this alternative variation of the present method, used as a basis in determining a product identifier (step 40). It should be further noted that, according to yet another alternative method, the data further represents manufacture-distinguishing information including, but not limited to a manufacturing lot code (e.g. a year/week code), a product serial number or other distinguishing information that can be used to further qualify the delivery of a product notice to a subset of products otherwise represented by a product identifier. The present method and scope of the claims appended hereto is not intended to be limited to any particular form of data perceived in reflected optical energy. Accordingly, so long as the data perceived in reflected optical energy can be used to identify a product type (e.g. by means of a product identifier), this variation of the present method may be utilized to perceive a candidate product.

In many applications, a product notice is directed to a subset of products within a particular product type, as adequately described in all of the incorporated references. As such, additional information, according to one alternative method, is perceived in the reflected optical energy. Said additional information, according to one alternative method, comprises a manufacturing lot code. It should be noted that a typical bar-code is encoded with information known as a universal product code (UPC). Typically, a common bar-code includes only a UPC code. Such common bar-codes typically do not included information pertaining to manufacturing lot for a particular product or other information that can be used to distinguish a subset of products within a particular product type. However, this does not preclude the use of a special bar-code that includes information pertaining to a manufacturing lot of other information that can be used to further distinguish a particular subset of products associated with a particular product type.

FIG. 2 further illustrates that, according to one alternative example method, once at least one of a product code and manufacturing lot information are optically perceived, this information is stored in a candidate product list (step 42). According to one example method, a product code perceived optically is stored in said the candidate list. According to one alternative method, manufacturing lot information is stored in the candidate list in addition to the product code. As an apparatus capable of conveying the product notice to a user continues to operate, it accumulates information about various products that is perceives over time (e.g manufacturing lots, serial numbers) that it is likely to encounter. Accordingly, such a candidate list is consulted when a product notice is received on a selective basis (Cf. as described with reference to FIG. 1B). Also, according to one variation of the present method, the candidate list is used to determine if a product notice is received for a product that was previously perceived according to the present method. In such case, a received product notice can be presented to a user even if there is no perception of the product after the product notice is received.

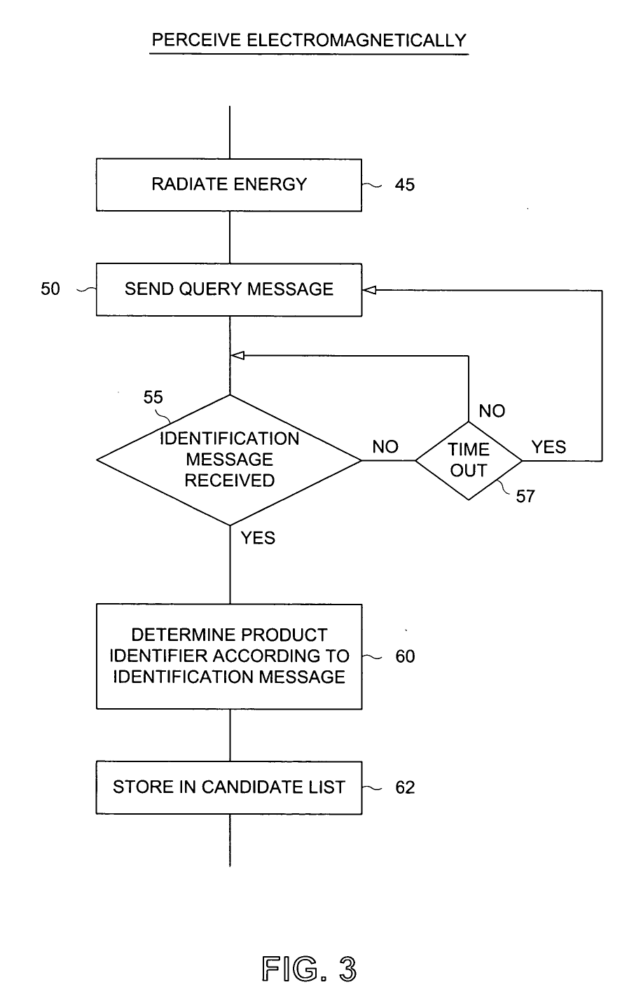

FIG. 3 is a flow diagram that depicts one alternative example method for perceiving a candidate product using electromagnetic (e.g. radio) energy. According to this alternative example method, electromagnetic energy is disseminated, i.e. radiated (step 45). It should be noted that a candidate product may potentially be illuminated with the electromagnetic energy. However, the present method simply disseminates electromagnetic energy and a candidate product may not be within range of the disseminated electromagnetic energy. According to one alternative variation of this method, the electromagnetic energy comprises radio energy. A query message is sent (step 50). This, according to one variation of the present method, is accomplished by modulating the electromagnetic energy. It should be noted that a candidate product may or may not be within the range of the radio energy. A candidate product that receives the query message responds with an identification message. This identification message is then received (step 55). According to yet another variation of the present method, a product identifier is determined according to information included in the identification message, or otherwise received from a radio frequency identification transponder responsive to the disseminated electromagnetic energy (step 60).

In the event that an identification message is not received within a particular time interval (step 57), the query message is resent. This present method, according to one example variation, conforms to various protocols used by wireless inventory management mechanisms (e.g. radio frequency identification transponders). According to one illustrative derivative method, interaction with a candidate product is conducted according to an “air-interface” specification peculiar to a particular radio frequency identification (RFID) transponder. For example, one particular RFID transponder is responsive to radio frequency energy modulated according to a standard known as “ISO/IEC 18000 Information Technology AIDC Techniques-RFID for Item Management—Air Interface”. This standard includes various subsection including:

18000-1 Part 1—Generic Parameters for the Air Interface for Globally Accepted Frequencies

18000-2 Part 2—Parameters for Air Interface Communications below 135 kHz

18000-3 Part 3—Parameters for Air Interface Communications at 13.56 MHz

18000-4 Part 4—Parameters for Air Interface Communications at 2.45 GHz

18000-5 Part 5—Parameters for Air Interface Communications at 5.8 GHz

18000-6 Part 6—Parameters for Air Interface Communications at 860 to 930 MHz

18000-7 Part 7—Parameters for Air Interface Communications at 433 MHz

It should be noted that the scope of the claims appended hereto is not intended to be limited to any particular standard for an “air-interface”. Accordingly, so long as a wireless interface is utilized to discover the identity of a product, the present method may be applied. It should be further noted that, according to yet another illustrative example of the present method, a plurality of query messages are sent on periodic basis in order to discover a plurality of products that may lie within the range of the disseminated electromagnetic energy. For example, the air-interface utilized by many RFID transponders provides for “multiple read” operation. Accordingly, such application of the present method may be utilized to present product notices for a plurality of products that are perceived in a substantially contemporaneous manner.

FIG. 3 further illustrates that, according to one alternative example method, once at least one of a product code and manufacturing lot information are perceived using electromagnetic radiation, this information is stored in a candidate list (step 62). According to one example method, a product code perceived wirelessly using electromagnetic radiation is stored in said the candidate list. According to one alternative method, manufacturing lot information is stored in the candidate list in addition to the product code. As an apparatus capable of conveying a product notice to a user continues to operate, it accumulates information about the products and corresponding manufacturing lots that it is likely to encounter. In an alternative method, the candidate list is pre-loaded based on a priori knowledge of potential candidate product lists. For example, where the present method is applied in a point-of-sale application, the candidate list is pre-programmed according to an inventory list that specifies the products carried by a store. Accordingly, such a candidate list can be consulted when a product notice is received on a selective basis.

According to one variation of the present method, the candidate list is used to determine if a product notice is received for a product that was previously perceived according to the present method. In this situation, a product identifier included in a received product notice is compared to the contents of the candidate list. In the case that a product identifier in the candidate list is found to be substantially equivalent to the product identifier included in a received product notice, the product notice is presented to a user.

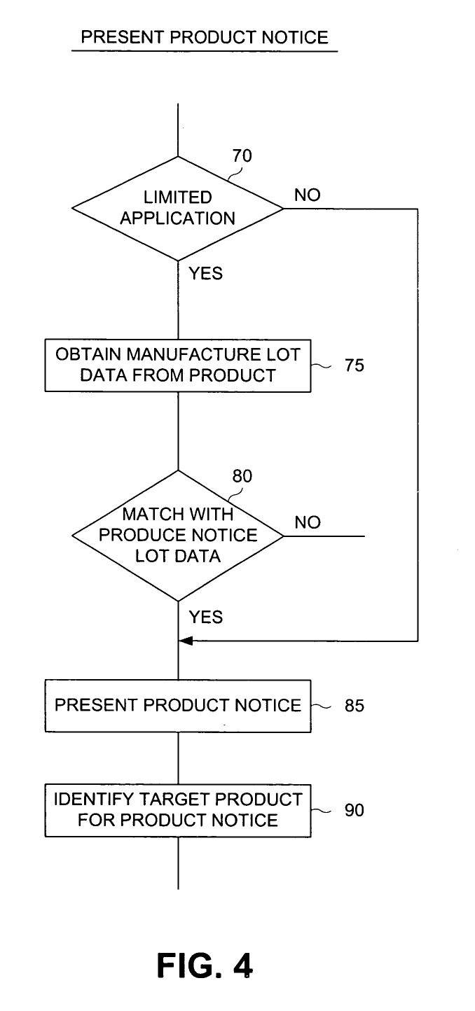

FIG. 4 is a flow diagram that depicts one alternative example method for presenting a product notice. According to this alternative example method, the scope of application of a particular product notice is determined (step 70). In the event any particular product notice is targeted to all products of a certain type, the product notice is presented to a user (step 85). Such presentation, according to one variation of the present method, includes at least one of an audible indication and a visible indication. A visible indication includes, but is not limited to a single indicator and a textual message. In the event any particular product notice is only applicable to a subset of products within a particular product type, additional manufacture-distinguishing information (e.g. manufacturing lot information and serial number) is obtained from the candidate product (step 75). The product notice is presented to a user using additional information obtained from the candidate product so as to qualify the candidate product within the limited scope of application of a particular product notice (step 80). According to one alternative method, the steps of determining the scope of application of a particular product notice and the subsequent steps of determining if the particular product notice is applicable to a particular candidate product according to additional discriminating information obtained from the product are optional steps. Accordingly, the product notice is merely presented to user (step 85) whenever a particular product notice is targeted to a candidate product perceived according to the present method.

FIG. 1 further illustrates that, according to yet another variation of the present method, a notice message is directed to a wireless transponder included in a candidate product. Typically, this is not accomplished until a product is once again perceived subsequent to the receipt of a product notice. According to yet another variation of the present method, the notice message directed to a wireless transponder is generated according to a product notice that was targeted to a candidate product represented in a candidate product list.

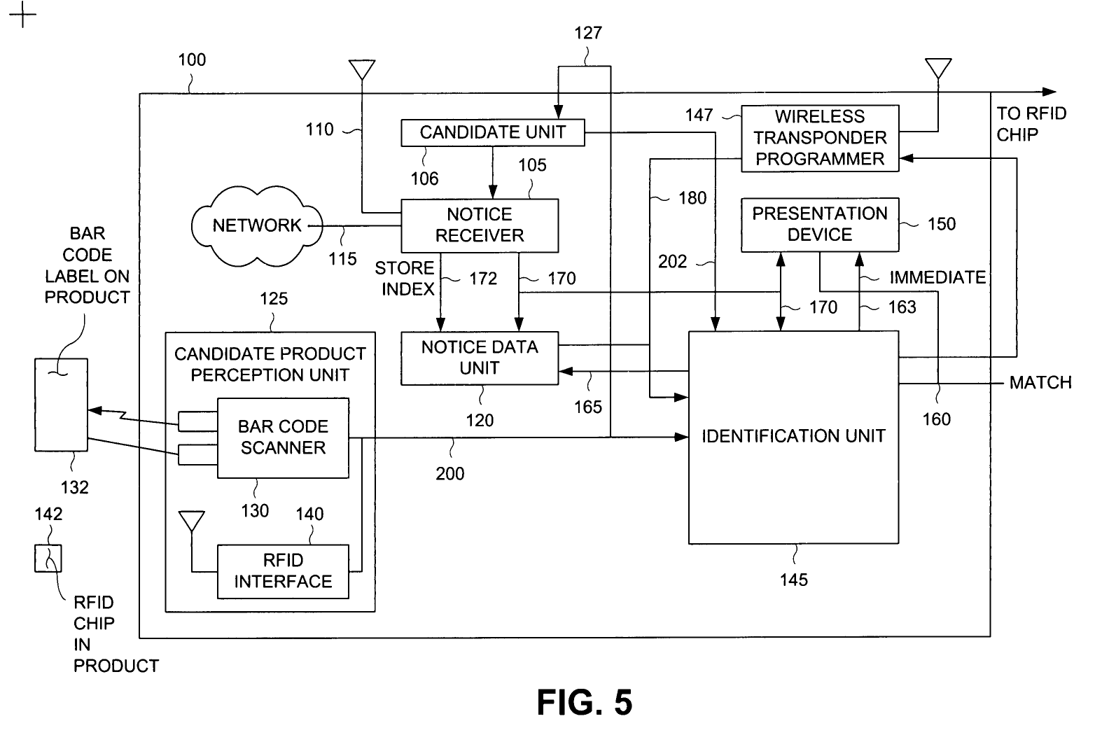

FIG. 5 is a block diagram that depicts one example embodiment of a product notice presentation device. According to this example embodiment, a product notice presentation device 100 comprises a notice receiver 105, a notice data unit 120, a candidate product perception unit 125 and an identification unit 145. According to one alternative embodiment, the product notice presentation device further comprises a presentation device 150. According to this example embodiment, the notice receiver 105 is capable of receiving a product notice. The notice receiver 105 comprises at least one of a wired 115 notice receiver and a wireless 110 notice receiver, each of which is capable of receiving a product notice. Examples of a wired notice receiver include, but are not limited to a telephone modem interface, a computer network interface, a cable television distribution system interface, an AC data interface (e.g. “home plug”), a serial data interface and a parallel data interface. Examples of a wireless notice receiver include, but are not limited to a radio frequency receiver, a wireless computer network interface (e.g. 802.11), a direct broadcast satellite receiver and a cellular telephone circuit capable of interacting with a cellular telephone system.

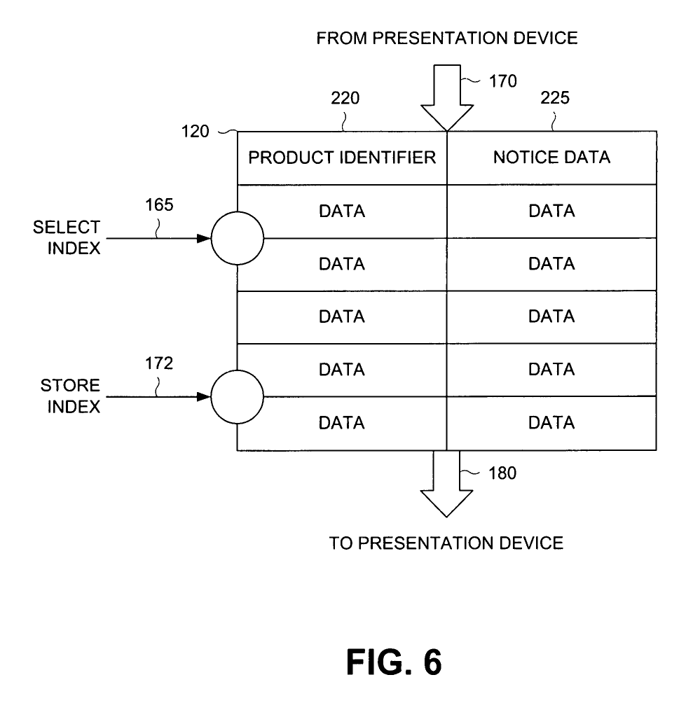

FIG. 6 is a block diagram of one example embodiment of a notice data unit. According to this example embodiment, the notice data unit 120 is capable of storing product notices 170 received by the notice receiver 105. The notice data unit 120, according to one alternative embodiment, receives a storage index 172 from the notice receiver 105 whenever a new product notice is received. Accordingly, the notice data unit 120 stores a product identifier 220 and notice data 225 for each product notice 170 received from the notice receiver 105. The notice data unit 120 provides notice data 180 to a presentation device 150 according to a select index 165 received from the identification unit 145. It should be noted that, according to yet another alternative embodiment, the identification unit 145 retrieves a product identifier using the selecting index 165 as more fully described infra. It should be appreciated that a typical product notice includes a notice data, which according to one variation of the present method comprises alphanumeric information, and a target product identifier. The target product identifier is stored in the product identifier 220 of the notice data unit 120 in a record along with the notice data, which is stored in the notice data field 225 of the same record.

FIG. 5 further illustrates that the candidate product perception unit 125, according to one alternative embodiment, comprises a bar-code scanner 130 which is capable of receiving information from a bar-code 132, which is typically included on a potential candidate product. In yet another illustrative alternative embodiment, the candidate product perception unit 125 comprises a wireless identification transponder interface 140, e.g. an interrogator or programmer. An interrogator is an apparatus capable of receiving identification information from a wireless identification transponder. A programmer is an apparatus capable of programming information into a wireless identification transponder. The wireless identification transponder interface 140, according to one alternative embodiment, is capable of interacting with at least one of a SmartChip™ and an RFID transponder. According to this illustrative alternative embodiment, the candidate product perception unit 125 is capable of receiving information from the wireless identification transponder interface 140, said information being obtained from a wireless identification transponder 142 included in the candidate product or in its packaging.

Using at least one of information received from a bar-code scanner 130 and information received from a wireless identification transponder interface 140, the candidate product perception unit 125 determines a product identifier and delivers 200 this to the identification unit 145. The identification unit 145 generates a select index 165 as a means of searching various records stored in the notice data unit 120. When a product notice having a product identifier (220 in FIG. 6) substantially equivalent to the product identifier received 200 from the candidate product perception unit 125, the identification unit 145 issues a MATCH signal 160. It should be noted that, according to yet another alternative embodiment, the scope of application of a particular product notice may be limited to a subset of products of a particular product type. In this situation, either of the bar-code scanner 130 and the wireless identification transponder interface 140 is further capable of retrieving additional information from a candidate product in order to further distinguish the candidate product as a member of the target subset (e.g. manufacture-distinguishing information). Corresponding information from a product notice is also stored in the notice data unit 120 and is used in this search process.

In response to the MATCH signal 160, the presentation device 150 retrieves a notice data (225 in FIG. 6) stored in the notice data unit 120. It should be noted that retrieval of the notice data 225 is accomplished using the select index 165 generated by the identification unit 145. The identification unit 145 maintains a select index 165 as long as the MATCH signal 160 is asserted. This allows the presentation device 150 to retrieve the notice data 225 according to the select index 165 generated by the identification unit 145. The presentation device 150 then presents the notice data to a user.

According to one alternative embodiment of a product notice presentation device, the candidate product perception unit 125 directs 127 a product identifier to a candidate unit 106 included in this alternative embodiment. Accordingly, the candidate unit 106 maintains an enumeration of various product identifiers associated with various candidate products perceived either by way of the bar-code scanner 130 or the wireless identification transponder interface 140 or other product perception device 125. According to one additional alternative embodiment, the notice receiver 105 filters product notices received by means of either the wireless 110 or wired 115 interfaces using the enumeration of product identifiers maintained in the candidate unit 106. Accordingly, the notice receiver 105 of this alternative embodiment will only forward a product notice 170 to the notice data unit 120 when the product notice is targeted to a product identifier included in the enumeration of product identifiers maintained in the candidate unit 106. It should thus be appreciated that one or more products can be perceived and cataloged in the candidate unit, such cataloging comprising the storage of a product identifier for a product perceived by the candidate product perception unit 125, and used to filter subsequently arriving product notices received by the notice receiver 105.

According to yet another alternative embodiment, the identification unit 145 receives a product notice 170 directly from the notice receiver 105. According to this alternative embodiment, the identification unit 145 generates a MATCH signal 160 when a product identifier included in the received product notice 170 is substantially equivalent to a product identifier stored in the candidate unit 106 as received 202 by the identification unit 145. In this event, the identification unit 145 directs the presentation unit 150 to present notice data included in the received product notice 170. Such direction of the presentation device 150, according to one example embodiment, is accomplished through the use of an IMMEDIATE signal 163. Accordingly, in response to the IMMEDIATE signal 163, the presentation device 150 of this alternative embodiment captures the notice data included in the received product notice 170 and presents the notice data to a user.

FIG. 5 also illustrates that, according to yet another alternative embodiment, a product notice presentation device further comprises a wireless transponder programming interface 147. In this alternative embodiment, product notice information included in the received product notice 170 (or from a product notice stored in the notice data unit 120) is direct to a wireless identification transponder included in a product or its packaging substantially contemporaneously with perception of a candidate product. It should be appreciated that the data may be altered to suit a particular notice requirement before it is directed to the wireless transponder programming interface 147. According to one alternative embodiment, the identification unit 145 generates a message according to a product notice and directs the generated message to the wireless transponder programming interface 147.

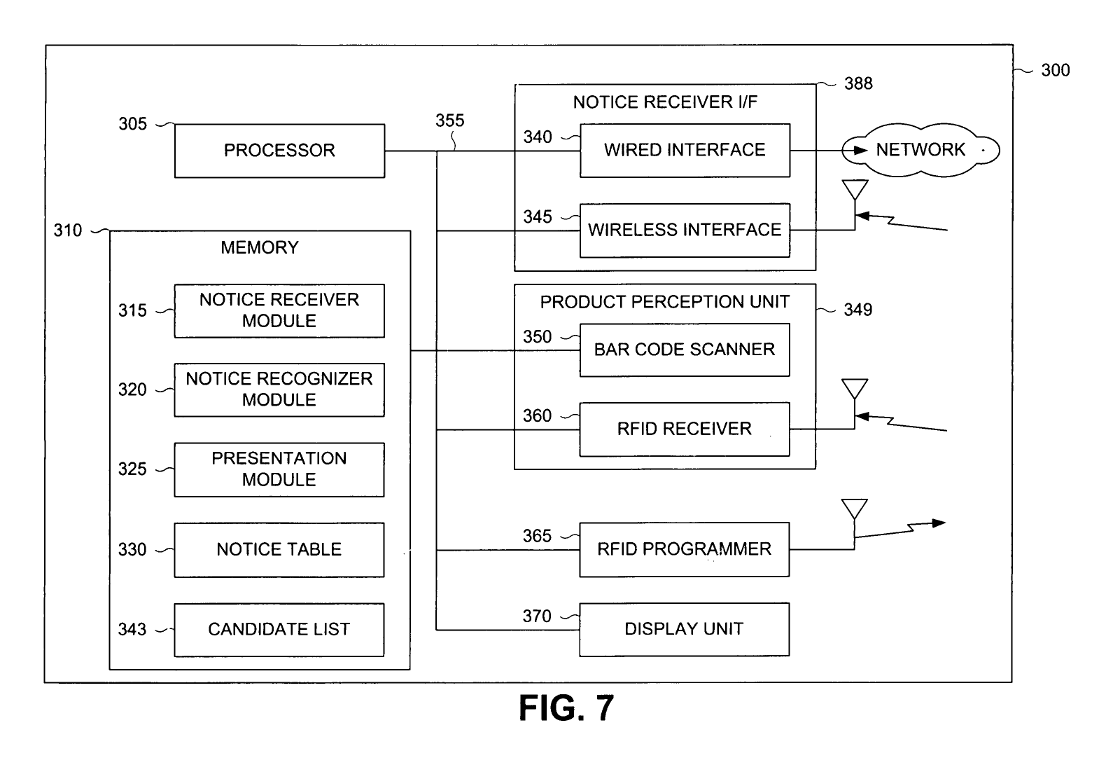

FIG. 7 is a block diagram of one illustrative embodiment of a processor-based product notice delivery apparatus. According to this alternative embodiment, a product notice delivery apparatus 300 comprises one or more processors 305 for executing instructions, a memory 310 and peripherals that vary according to alternative embodiments herein described. The processor 305 is capable of communicating with the memory and the varied peripherals by means of a system bus 335.

This alterative illustrative embodiment comprises various functional modules each of which comprises an instruction sequence that can be executed by the one or more processors (hereinafter “processor”) 305. For purposes of this disclosure, a functional module and its corresponding instruction sequence is referred to by a process name. The instruction sequence that implements the process name, according to one alternative embodiment, is stored in the memory 310. The reader is advised that the term “minimally causes the processor” and variants thereof is intended to serve as an open-ended enumeration of functions performed by the processor 305 as it executes a particular functional process (i.e. instruction sequence). As such, an embodiment where a particular functional process causes the processor 305 to perform functions in addition to those defined in the appended claims is to be included in the scope of the claims appended hereto.

Stored in the memory are one or more instruction sequences including, but not limited to a notice receiver module 315, a notice recognizer module 320 and a presentation module 325. According to one alternative embodiment, a notice message is stored in a portion of the memory 315 referred to as a notice table 330. According to yet another alternative embodiment, a portion of the memory 315 is referred to as a candidate list 343 and is used to store product identifiers for products that have been perceived by the presently described apparatus.

In one alternative embodiment, the product notice delivery apparatus 300 further comprises a product perception unit 349 that, according to yet another alternative embodiment, comprise at least one of a bar-code scanner 350 and a wireless identification transponder interface 360 (e.g. an RFID interrogator) capable of obtaining information from a wireless identification transponder included in a candidate product or in its packaging. According to yet another alternative embodiment, the product notice delivery apparatus 300 further comprises a wireless identification transponder programmer 365. According to yet another alternative embodiment, the product notice delivery apparatus 300 further comprises a display unit 370.

In yet another alternative embodiment, the product notice delivery apparatus 300 further comprises a notice receiver interface 338. The notice receiver interface 338, according to yet another alternative embodiment, comprises at least one of a wireless interface 345 and a wired interface 340, commensurate with the descriptions of such interfaces herein provided, supra.

The functional processes (and their corresponding instruction sequences) described thus far that enable the delivery of product notices through transient perception of a candidate product are, according to one alternative embodiment, imparted onto computer readable medium. Examples of such medium include, but are not limited to, random access memory, read-only memory (ROM), CD ROM, floppy disks, hard disk drives and magnetic tape. This computer readable medium, which alone or in combination can constitute a stand-alone product, can be used to convert at least one of a general-purpose computing platform, a point-of-sale terminal and a retail-shelf inventory management wireless identification transponder interrogator (or programmer) into a device for presenting product notices according to the techniques and teachings presented herein. Accordingly, the claims appended hereto are to include such computer readable medium imparted with such instruction sequences that enable execution of the present method and all of the teachings herein described.

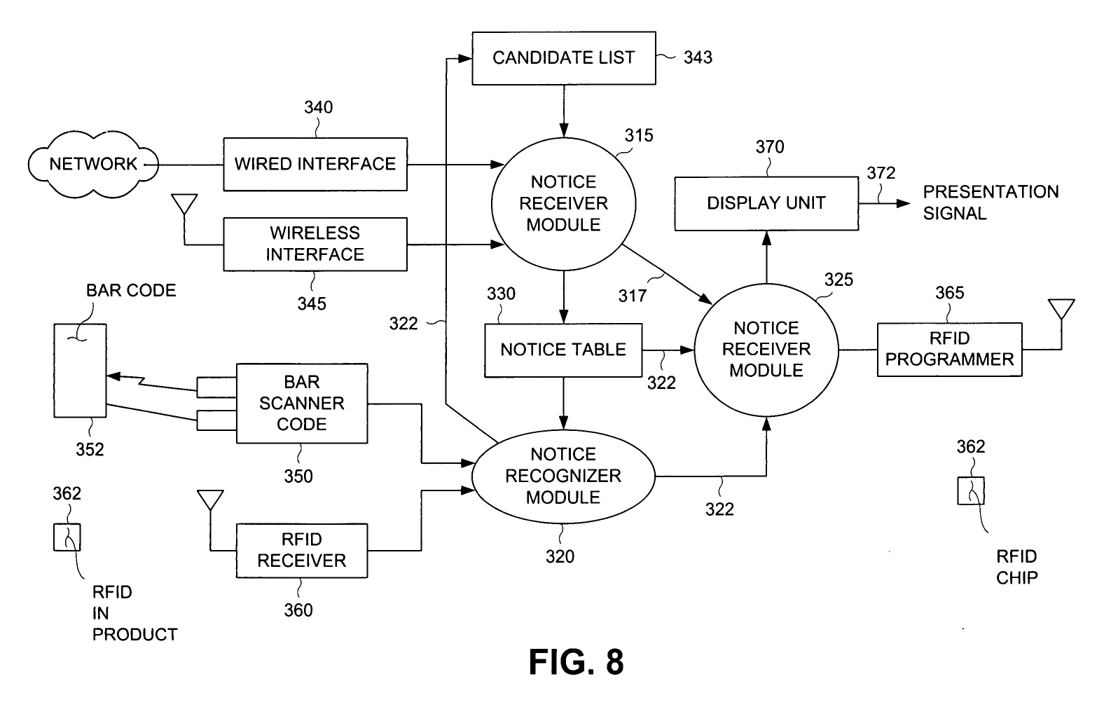

FIG. 8 is a data flow diagram that depicts the internal operation of several illustrative embodiments of a processor-based product notice delivery apparatus. According to one example embodiment, the notice receiver module 315, when executed by the processor 305, minimally causes the processor to receive a product notice from at least one of the wired interface 340 and the wireless interface 345. As the processor 304 continues to execute the notice receiver module 315, it will store the product notice in the notice table 330. According to yet another alternative example embodiment, the notice receiver module 315 minimally causes the processor 305 to store the product notice in the notice table 330 only when the product identifier included in the received product notice is substantially equivalent to a product identifier stored in the candidate list 343. According to yet another alternative embodiment, the notice receiver module 315 minimally causes the processor 305 to compare a product identifier included in a product notice with an enumeration of one or more product identifiers stored in the candidate list 343. In this alternative embodiment, the notice receiver module 315 further minimally causes the processor 305 to extract notice data from the received product notice and to forward 317 the notice data to the presentation module 325.

According to one exemplary embodiment, the notice recognizer module 320 minimally causes the processor 305 to determine a product identifier for a candidate product according to information received from at least one of the bar-code scanner 350 and the wireless identification transponder interface 360 (i.e. from the product perception unit 349). The notice recognizer module 320 further minimally causes the processor to retrieve a product notice from the notice table 330 according to the product identifier it determines according to information received from the product perception unit 349. This occurs when the apparatus is operating in a post-perception mode. In this mode, one or more product notices are received and stored. It is not until a candidate product is perceived and a notice for that product is found in the notice table does the processor present a notice message to a user by directing a notice data from the notice table 330 to the presentation module 325.

The presentation module, when executed by the processor 305, minimally causes the processor 305 to receive 322 the selected product notice and to make the product notice available to either of a user, a subsequent automated process or to direct the product notice to a product (e.g. by directing a message to the wireless transponder programmer 365). In yet another alternative embodiment, the notice recognizer module 320 further minimally causes the processor 305 to retrieve additional information from at least one of the bar-code scanner 350 and the wireless identification transponder interface 350. Such additional information comprises additional manufacture-distinguishing information to further qualify delivery of a product notice to a subset of products (e.g. a manufacturing lot, serial number and the like) within a particular product type.

In yet another exemplary embodiment, the notice recognizer module 320 further minimally causes the processor 305 to store a product identifier 322 for a perceived candidate product in the candidate list 343. In this alternative embodiment, the processor stores a product identifier before it ever receives a product notice that is targeted to the product corresponding to the stored identifier. In this alternative embodiment, the notice receiver module 315 receives a product notice from at least one of the wired interface 340 and the wireless interface 345. The notice receiver module 315 further minimally causes the processor to compare a product identifier included in the product notice to each product identifier stored in the candidate list 343. When a match is found, the notice receiver module 315 further minimally causes the processor to direct a notice data included in the product notice to the presentation module 325.

In one alternative embodiment, the presentation module 325 minimally causes the processor 305 to direct a product notice (including at least one of a product identifier and notice data) to the display unit 370. The display unit generates a presentation signal 372. Examples of a presentation signal include, but are not limited to an audio signal, a composite video signal, red-green-blue drive signals and a digital video interface suitable for driving, inter alia, a liquid crystal display device.

In yet another alternative embodiment, the presentation module 325 minimally causes the processor 305 to direct the product notice (including at least one of a product identifier and notice data) to a wireless identification transponder programmer 365. In this case, the wireless identification transponder programmer 365 (e.g. an RFID programmer) directs the product identifier and the notice data to a wireless identification transponder included in a target product or in its packaging. It should be appreciated that, according to yet another alternative example embodiment, the presentation module generates a notice message that is programmed into a transponder using the transponder programmer 365. The notice message is generated according to the product notice received by the processor as it executes one alternative embodiment of a notice receiver module 315.

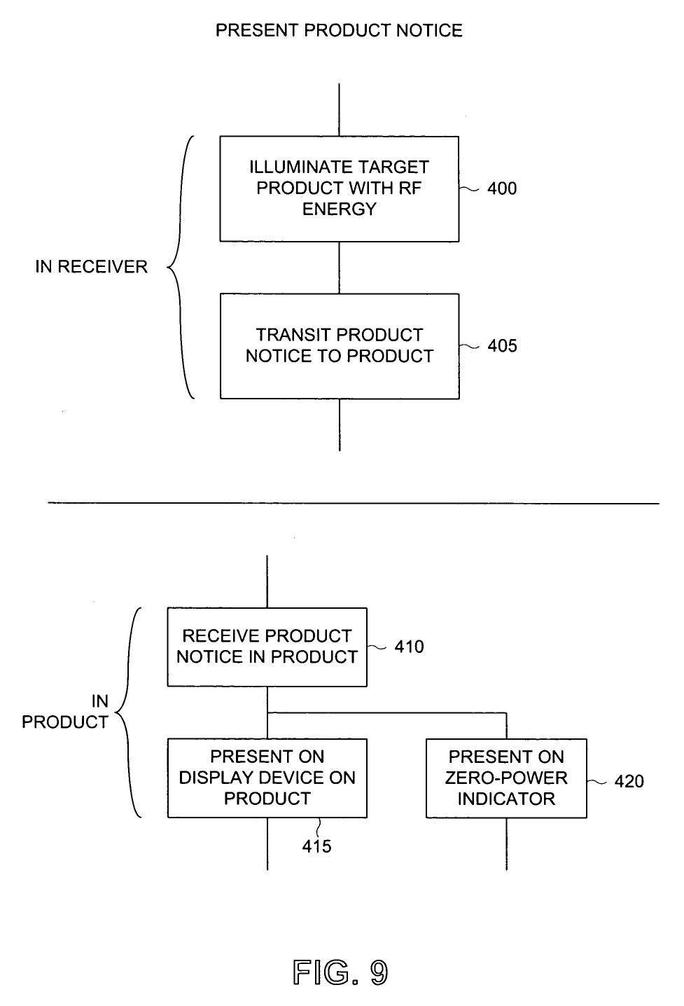

FIG. 9 is a flow diagram that depicts one alternative method for presenting a product notice to a user. According to this alternative method, presentation of a product notice is accomplished by illuminating a target product with radio frequency energy (step 400). A product notice is then directed to the target product (step 405). A wireless identification transponder included in the target product or in its packaging receives the product notice (step 410). The product notice is then presented on a display device (step 415) included in the target product or in its packaging. For example, one alternative method presents the product notice by heating a thermochromic ink. The thermorchromic ink, according to one alternative method, comprises irreversible thermorchromic ink such that once it is heated to a pre-established set-point, a product notice will persist event after the application of heat is subsequently discontinued. Thermochromic ink is an ink that changes in transmissivity and/or color according to temperature. According to one alternative method, the presentation of the product notice is accomplished by changing the orientation of magnetically active molecules according to an electric signal. The resulting orientation is maintained after the electrical signal is removed. This method of presentation is commonly embodied in a “zero-power” liquid crystal display device (step 420).

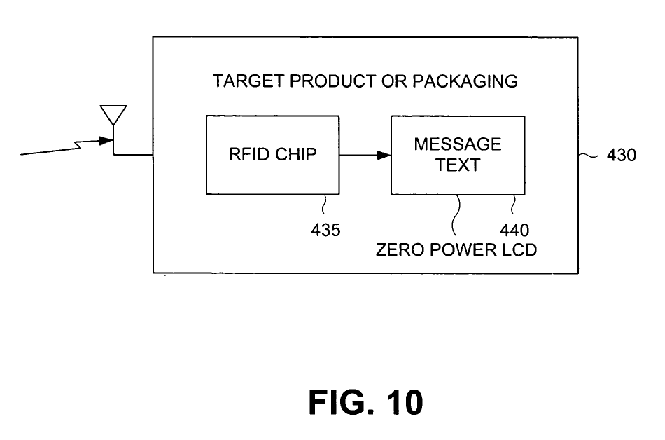

FIG. 10 is a block diagram of one alternative embodiment of a product notice presentation device. According to this alternative embodiment, a wireless identification transponder 435 is included in at least one of a target product 430 or in its packaging. Packaging can include, but is not limited to a cardboard or chipboard enclosure that envelopes a product and a prescription vile for the containment of medication (e.g. pills, ointments, etc.). Also included in at least one of the product 430 or in its packaging is a display device 440. According to one alternative example embodiment, the display device comprises a zero-power liquid crystal display device. According to yet another alternative embodiment, the display device comprises a thermochromic ink and a heating element for heating the thermochromic ink to a pre-established set-point temperature. It should be noted that an irreversible thermochromic ink is a useful indicator when a product becomes unfit either by way of exposure to a pre-established temperature or a product notice warning of unfit status (e.g. recall) of the product.

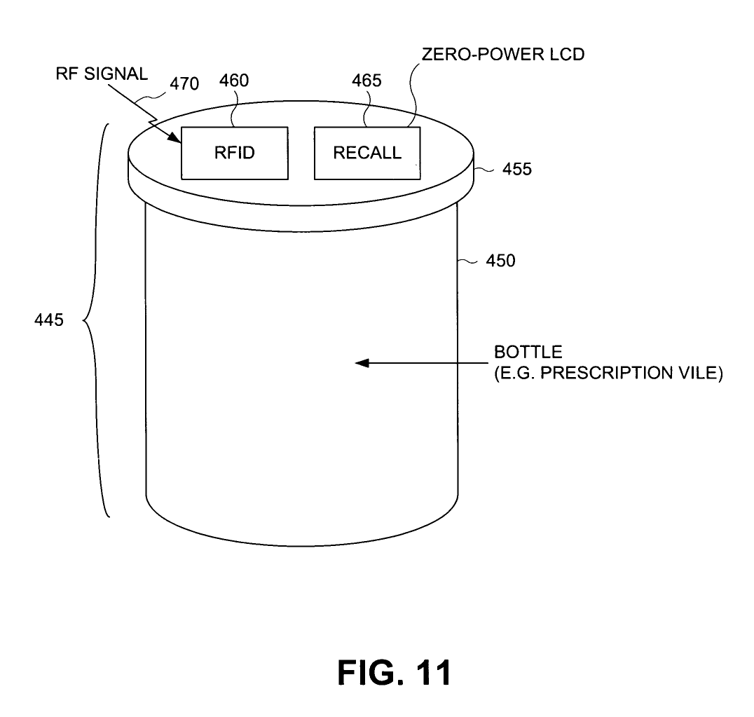

FIG. 11 is a pictorial diagram that depicts one example of a package that includes a display capability. According to this example embodiment, product packaging comprises a medication container 445 that includes a container element 450 and a cover element 455. According to this alternative embodiment, the cover element comprises a wireless identification transponder 460 and a display device 465. The wireless identification transponder 460 typically receives power and a product notice by way of a radio frequency signal 470. The wireless identification transponder 460 extracts notice data from a received product notice and directs this to the display device 465. The display device 465 comprises at least one of a zero-power liquid crystal display device and a combination of thermochromic ink and a heating element. Power for the display device 465 is also obtained from the radio frequency signal received by the wireless identification transponder 460. In the case of a zero-power liquid crystal display, the presentation will continue even after the radio frequency signal 470 is no longer providing power to the wireless identification transponder 460. According to one alternative embodiment, the wireless identification transponder 460 and the display device 465 are included in the container element 450.

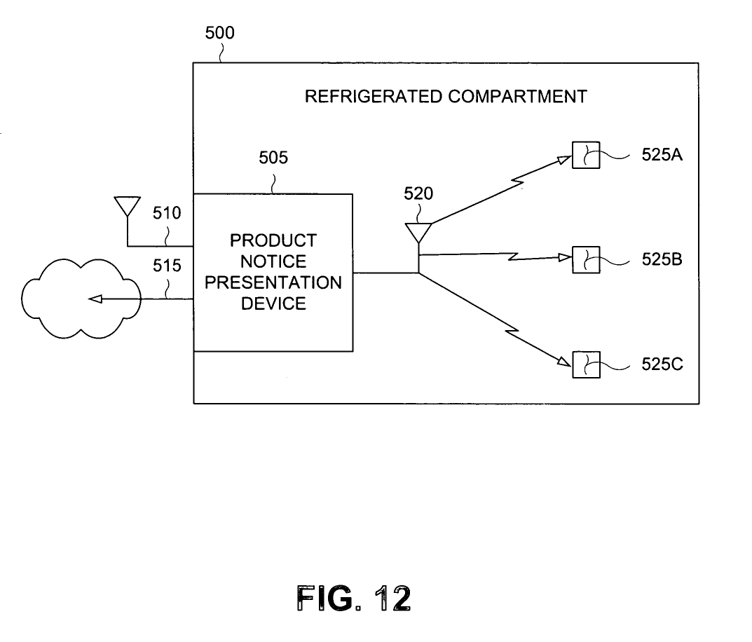

FIG. 12 is a block diagram that depicts one example embodiment of a refrigerated storage unit that includes a product notice presentation device. According to this example embodiment, a refrigerated storage unit (e.g. a household refrigerator or a retail display unit) comprises a refrigerated compartment 500 and a product notice presentation device 505 commensurate with the teachings and descriptions provided herein. In operation, the product notice presentation device 505 receives a product notice by means of at least one of a wire interface 515 and a wireless interface 510. When a candidate product is perceived, for example by way of a wireless identification transponder interface 520, a product notice is presented to a user according to the methods and apparatus described herein.

While the present method and system have been described in terms of several alternative methods and embodiments, it is contemplated that alternatives, modifications, permutations, and equivalents thereof will become apparent to those skilled in the art upon a reading of the specification and study of the drawings. It is therefore intended that the true spirit and scope of the appended claims include all such alternatives, modifications, permutations, and equivalents.

The type and mode of reception of a product notice is described in the incorporated references. As such, all embodiment herein described can be modified to include all variations of wired and wireless means for receiving a product notice described herein and in the incorporated references.

1. A method for presenting a product notice comprising:
receiving a product notice;
perceiving a candidate product;
determining a product identifier according to information obtained from the perceived candidate product; and
presenting the product notice when the product identifier for the candidate products indicates that the product notice is targeted to the candidate product.

2. The method of claim 1 wherein receiving a product notice comprises: receiving a product notice using at least one of a wired interface and a wireless interface.

3. The method of claim 1 wherein receiving a product notice comprises storing the product notice in a notice table when the product notice is targeted to a potential candidate product.

4. The method of claim 1 wherein perceiving a candidate product comprises:
providing optical energy;
perceiving data in a reflected portion of the optical energy; and
determining a product identifier according to the perceived data.

5. The method of claim 4 further comprising determining product-manufacture discrimination data according to the perceived data.

6. The method of claim 1 wherein perceiving a candidate product comprises:
providing electromagnetic energy;
sending a query message by means of the electromagnetic energy;
receiving an identification message from a wireless transponder included in a potential candidate product; and
determining a product identifier according to the identification message.

7. The method of claim 6 further comprising determining product-manufacture discrimination data according to the received identification message.

8. The method of claim 6 further comprising directing to the wireless transponder included in a potential product a notice message generated according to the product notice.

9. The method of claim 1 further comprising storing a plurality of product identifiers in a potential candidate list.

10. A product notice presentation device comprising:
notice receiver capable of receiving a product notice;
notice data unit capable of storing a received product notice;
candidate product perception unit capable of perceiving a candidate product and generating a product identifier in accordance with said perception;
candidate product unit capable of storing a candidate product identifier received from the candidate product perception unit;
identification unit capable of identifying a product notice stored in the notice data unit that is addressed to a candidate product according to a candidate product identifier stored in the candidate product unit; and
presentation device capable of presenting the identified product notice.

11. The product notice receiver of claim 10 wherein the notice receiver comprises at least one of a wired notice receiver and a wireless notice receiver.

12. The product notice receiver of claim 10 wherein a received product notice is stored in the notice data unit when the product notice is targeted to a product identifier found in said product candidate unit.

13. The product notice receiver of claim 10 wherein the candidate product perception unit comprises a bar-code scanner capable of providing a product identifier to the candidate product unit according to information obtained from a bar-code.

14. The product notice receiver of claim 13 wherein the bar-code scanner is further capable of providing product manufacture-distinguishing information to the candidate product unit.

15. The product notice receiver of claim 10 wherein the candidate product perception unit comprises a wireless identification transponder interface capable of providing a product identifier to the candidate product unit according to information obtained from a wireless identification transponder.

16. The product notice receiver of claim 15 wherein the wireless identification transponder interface is further capable of providing manufacture-distinguishing information to the candidate product perception unit.

17. The product notice receiver of claim 15 wherein the wireless identification transponder interface is further capable of directing to a wireless identification transponder a notice message received from the identification unit and wherein the identification unit is further capable of generating a notice message in accordance with a product notice stored in the notice data unit when such product notice is directed to product identified by a product identifier stored in the candidate product unit.

18. The product notice receiver of claim 10 wherein the candidate product unit is capable of storing a plurality of product identifiers.

19. A product notice delivery apparatus comprising:
processor capable of executing instruction sequences;
memory capable of storing one or more instruction sequences;
notice receiver interface capable of receiving a product notice;
product perception unit capable of perceiving a candidate product;
presentation unit capable of presenting a product notice; and
functional modules embodied as instruction sequences stored in the memory including:
notice receiver module that, when executed by the processor, minimally causes the processor to receive a product notice and to store the product notice in a notice table;
notice recognition module that, when executed by the processor, minimally causes the processor to receive a product identifier from the product perception unit and to further select a product notice from the notice table that is associated with the received product identifier; and
presentation module that, when executed by the processor, minimally causes the processor to direct the selected product notice to the display unit.

20. The apparatus of claim 19 wherein the notice receiver interface comprises at least one of a wired interface and a wireless interface.

21. The apparatus of claim 19 wherein the notice receiver module further minimally causes the processor to store a product notice in a notice table when the product notice is targeted to a product that is listed in a candidate list.

22. The apparatus of claim 19 wherein the product perception unit comprises a bar-code scanner.

23. The apparatus of claim 22 wherein the notice recognizer module, when executed by the processor, further minimally causes the processor to receive additional manufacture-distinguishing information from the bar-code scanner.

24. The apparatus of claim 19 wherein the product perception unit comprises a wireless identification transponder interface.

25. The apparatus of claim 22 wherein the notice recognizer module, when executed by the processor, further minimally causes the processor to receive additional manufacture-distinguishing information from the wireless identification transponder interface.

26. The apparatus of claim 22 wherein the wireless identification transponder interface comprises a programmer.

27. A product notice delivery apparatus comprising:
processor capable of executing instruction sequences;
memory capable of storing one or more instruction sequences;
notice receiver interface capable of receiving a product notice;
product perception unit capable of perceiving a candidate product;
presentation unit capable of presenting a product notice; and
functional modules embodied as instruction sequences stored in the memory including:
notice recognition module that, when executed by the processor, minimally causes the processor to receive a product identifier from the product perception unit and to store the product identifier in a candidate product list in the memory;
presentation module that, when executed by the processor, minimally causes the processor to direct a notice data included in a product notice to the display unit; and
notice receiver module that, when executed by the processor, minimally causes the processor to receive a product notice and direct a notice data to the presentation module when a product identifier included in a received product notices is substantially equivalent to a product identifier stored in the candidate product list.

28. The product notice delivery apparatus of claim 27 wherein the product candidate presentation unit comprises at least one of a bar-code scanner and a wireless identification transponder interface.

29. The product notice delivery apparatus of claim 27 further comprising a wireless identification transponder programmer and wherein the notice receiver module directs to wireless identification transponder programmer a message generated according to a product notice received by the processor as it executes the notice receiver module.

30. A refrigeration unit comprising:
chilled compartment; and
product notice delivery apparatus comprising:
notice receiver capable of receiving a product notice;
notice data unit capable of storing a received product notice;
candidate product perception unit comprising a wireless identification transponder interface capable of perceiving a candidate product and generating a product identifier in accordance with said perception;
candidate product unit capable of storing a candidate product identifier received from the candidate product perception unit;
identification unit capable of identifying a product notice stored in the notice data unit that is addressed to a candidate product according to a candidate product identifier stored in the candidate product unit; and
presentation device capable of presenting the identified product notice.

31. A refrigeration unit comprising:
chilled compartment; and
product notice delivery apparatus comprising:
processor capable of executing instruction sequences;
memory capable of storing one or more instruction sequences;
notice receiver interface capable of receiving a product notice;
product perception unit comprising a wireless identification transponder interface capable of perceiving a candidate product;
presentation unit capable of presenting a product notice; and
functional modules embodied as instruction sequences stored in the memory including:
notice recognition module that, when executed by the processor, minimally causes the processor to receive a product identifier from the product perception unit and to store the product identifier in a candidate product list in the memory;
presentation module that, when executed by the processor, minimally causes the processor to direct a notice data included in a product notice to the display unit; and
notice receiver module that, when executed by the processor, minimally causes the processor to receive a product notice and direct a notice data to the presentation module when a product identifier included in a received product notices is substantially equivalent to a product identifier stored in the candidate product list.

32. A method for presenting a product notice comprising:
receiving a message in a product from a message forwarding apparatus;
presenting information to a user according to the received message.

33. The method of claim 32 wherein presenting information to a user comprises:
presenting information to a user by altering the orientation of magnetically active molecules according to an electrical signal;
maintaining the altered orientation when the electrical signal is not active.

34. The method of claim 32 wherein presenting information to a user comprises:
presenting information to a user by changing at least one of the transmissivity and color of a material by imparting energy to said material; and
maintaining at least one of the resulting transmissivity and color of a material when no additional energy is imparted to said material.

35. A product tagging device comprising:
radio identification transponder capable of receiving a notice message; and
display element capable of presenting information according to a received notice message.

36. The product tagging device of claim 35 wherein the display element comprises a zero-power liquid crystal display.

37. The product tagging device of claim 35 wherein the display element comprises a thermochromatic material and a heat generator wherein the thermochromatic material is disposed proximate to the heat generator and the heat generator is responsive to a message received by the radio identification transponder.

38. The product tagging device of claim 35 further comprising at least one of a container and a container lid.
